(19) United States
(12) Patent Application Publication
(10) Pub. No.: US 2025/0068143 A1
(43) Pub. Date: Feb. 27, 2025

(54) METHODS OF TOLERANCE ANALYSIS AND ADJUSTMENTS IN ADDITIVE MANUFACTURING

(71) Applicant: Desktop Metal, Inc., Burlington, MA (US)

(72) Inventor: Andrew Fiske ROBERTS, Charlestown, MA (US)

(21) Appl. No.: 18/815,892

(22) Filed: Aug. 27, 2024

Related U.S. Application Data
(60) Provisional application No. 63/534,847, filed on Aug. 27, 2023.

(51) Int. Cl. G05B 19/4093

(52) U.S. Cl. CPC G05B 19/40935; G05B 2219/49023

(57) ABSTRACT

A computer-implemented method includes obtaining an electronic design of a part geometry for a part for additive manufacturing; obtaining datum information indicating a sequence of one or more datums for the part geometry, obtaining a electronic scan mapping of an object additively manufactured according to the electronic design of the part geometry; sequentially aligning the electronic scan mapping to the electronic design of the part geometry according to the sequence of one or more datums indicated in the datum information; generating a deviation profile based on the alignment of the aligning the electronic scan mapping to the electronic design of the part geometry according to the sequence of one or more datums indicated in the datum information. The electronic design of the part geometry is adjusted based on the deviation profile to compensate for distortion. A further part can be manufactured based on the adjusted electronic design.

### RELATED APPLICATION(S)

This application claims priority to U.S. Provisional Patent Application Ser. No. 63/534,847, filed Aug. 27, 2023, entitled METHODS OF TOLERANCE ANALYSIS AND ADJUSTMENTS IN ADDITIVE MANUFACTURING; the contents of which are herein incorporated by reference in its entirety.

### FIELD

Various embodiments relate to additive manufacturing and improvements thereto.

### BACKGROUND

Few good tools exist for analyzing additive manufactured (AM) parts. Even fewer tools exist for correcting the geometric shapes of AM parts for defects. However, the disclosed methods analyze the distortion effects caused by additive manufacturing, relative to a set of defined tolerances, and then compensate by modifying the “green” as-printed shape in the regions that fall out of tolerance.

The lack of analysis and distortion compensation tools for AM is problematic. AM allows designers to print virtually any shape without having to incur all the typical costs of tooling and setup. Unlike with casting, injection molding, or CNC machining, AM enables direct part printing without the creation of molds or fixtures. This freedom to print any shape enables engineers to theoretically tweak design geometries in order to address distortions caused by shrinkage, gravity, and friction. The problem is that there are few tools available for analyzing and fixing part geometries. Existing CAD systems make it difficult to counter warp analytical surfaces such as planes and cylinders. Despite the dearth of scan-based analysis and compensation tools, many AM users have recently been buying digital scanners. New technologies have brought the prices of scanners down, and many are fast and easy to use. The problem is that many digital scanners typically provide primitive analysis tools for showing deviations as simple heat maps. Heat maps show a rainbow of colors the degree to which scanned regions lie inside (red) and outside (blue) of the part. While heat maps are better than nothing, they fail to indicate how a part matches up against required tolerances on a feature-by-feature basis. Heat maps fail to provide tolerance analysis according to the standard GD&T norms and practices.

### SUMMARY

Disclosed in various embodiments of the present disclosure is a tolerance analysis tool to analyze features on a scan (like holes, slots, and planes), and provide geometric dimensioning and tolerancing (GD&T) style tolerance analysis of individual features, in addition to the ability to automatically scan-adjust the green part at the feature level.”

Various embodiments of the present disclosure disclose methods that use scans to automatically generate tolerance analysis reports. Users may provide a software application with definitions of features, datums, and tolerances relative to a CAD part, and then the software reads one or more scans of the manufactured part and provides an analysis according to the GD&T specification. The disclosed methods of various embodiments can then apply feature-level scan adjustments to green part shapes based on the results of the tolerance-based scan analysis.

The following workflow is one example. First, a user creates a software model and adds a part using an STL, STEP, or Parasolid file, as those of ordinary skill in the art will appreciate. Next, the user selects surfaces on the part to be features, and indicates which features are datums. This includes analytical surfaces including planes, cylinders, cones, freeform surfaces, curves, lines and points. Finally, the user defines tolerances, and for each tolerance, indicates the type, target feature, tolerance value, referenced datums, and characteristics such as Max/Least Material Conditions. The user may define tolerances on features that are datums.

Once the model has been defined, scans of manufactured parts are read in. Users may read scans of multiple instances of parts and have the software automatically merge them into an averaged or composite scan. The disclosed methods include scan reading tools to remove noise and can easily handle dropouts and missing data, such as in unreachable internal passages. There are also tools for auto-combining partial scans and scans from cut parts. For example, scan reading methods are disclosed in US Patent Application US17/898,309, the contents of which are incorporated herein by reference.

FIG. 1 shows an example of a representation of a part 100, such as a model or electronic design of a part geometry, which can be form an electronic data file(s). As can be seen in FIG. 1, a plurality of datums are defined with respect to the part. In particular, the defined datum surfaces A, B, and Care labeled. Further, various features and tolerances of features can be defined with respect to the datums. In this example, the features 110a, 110b, and 110c are shown with tolerances. The feature 110a or surface 110a is defined with respect to the datum A with a parallelism tolerance. The feature 110b, the hole, is defined with tolerances with respect to datums B and C. Finally, a further tolerance, flatness, is defined with respect to feature or surface 110c.

Once a scan has been loaded, the disclosed methods automatically find the surfaces on the scan that correspond to the feature surfaces on the part. These are saved and highlighted. For example, FIG. 2 shows a side-by-side comparison of the electronic design for a part geometry 100 and a corresponding electronic scan mapping of a part 200 manufactured according to the part 100. The part 100 has datum surfaces defined. The tool/software obtains the electronic scan mapping 200 and auto-discovered scan surfaces; that is it can load the scan mapping 200 and then automatically find the scan surfaces corresponding to the datums defined with respect to the part 100.

Next, in at least one example, “Live Inspect” part of software performs an Align-to-Datums function. When scans are read in initially, they are aligned precisely to the part using an equal weighting of the scan points. But this is not sufficient for performing tolerance analysis because scans must be aligned with the part according to the datums defined on the part. Before the alignment begins, it can be specified, e.g., by a user a sequence of datums to be used for alignment. The process of aligning the scan according to a sequence of datums involves aligning the scan using the scan points corresponding to a first datum, relative to that datum, followed by partially aligning the scan using the same approach relative to a second datum, and so forth, until the scan is fully constrained and may not be moved any more. Each successive alignment of the scan to a datum must be done in a manner that does not break the alignment performed relative to previous datum alignments. The process is analogous to fixturing a manufactured part into a coordinate measuring machine, where one face of the part is placed on a surface, and then the part is slid along that surface until it makes contact with a second surface, and then where the part is further slid until it touches a final surface and is fully fixtured and may not move any further. During the Align to Datums function, the software applies a series of partial sequential transforms to the scan to align it with the part as if it were being fixtured to a coordinate measuring machine according to the datum definitions.

FIGS. 3A and 3B show an example of successive alignments of electronic design part 100 to the electronic scan mapping of manufactured part 200. That is FIGS. 3A and 3B show a sequence of partial translation and rotations is automatically applied to the scan 200 to align it with the part 100 via datums-mimicking how parts are fixtured in Coordinate Measuring Machine's (CMM's) prior to measuring.

Next, in the example, methods related to an analysis of each tolerance are performed. For example, for each tolerance, a fitted entity (i.e. surface, axis, point), is constructed through the associated scan surface data, and a volumetric tolerance zone is computed relative to the part. The fitted entity is measured to see if it falls within the bounds of the tolerance zone. When the analysis is complete, a tolerance “go-no-go” report is generated. Prior to analyzing each tolerance, the scan is aligned to the sequence of datums called out in the tolerance. Multiple tolerances may use the same sequence of alignments such that the scan may be aligned once to the part using the specified sequence, and then multiple tolerances may be evaluated without having to realign the scan to the part.

FIG. 4 shows a further exemplary representation of the part 100 which has been aligned to scan part 200. Once a scan, e.g., scan 200, has been aligned to the part 100, tolerances are analyzed by fitting entities such as planes, cylinders, and axes through scan data and evaluating against a set of volumetric tolerance zones. In this case a tolerance 110b is analyzed with respect to the defined tolerance zone T1, which in this example is a cylindrically shaped hole.

Finally, in the exemplary method or process, once tolerance analysis has been performed, the disclosed methods, e.g., software, provide a feature-level scan adjustment that corrects for deviations identified by the scan(s) and fitted to the datums. This is important because, otherwise, scan adjustment might be applied all over the part, when in fact, only regions of the part where features are out of tolerance need to be scan adjusted. For example, if a scan is fitted to a part using equal weight of all the scan points, the scan may not align well with any surfaces of the part. When scan adjustment is applied, all regions of the part geometry may be adjusted to compensate for the distortion of the scan. However, if the scan is aligned to the part first using a sequence of specified datums, then the scan adjustment will compensate for distortion more in the areas where features fall out of tolerance whereas areas where the scan is tightly fit to the datums will not require much or any deviation compensation.

The various methods described in exemplary embodiments can bee designed to be placed in an automated quality control pipeline. This means that the various methods may be invoked via a script to open a model containing a part, feature, datum, and tolerance definitions, load a set of scans, and perform tolerance analysis and feature-level scan adjustment, all without human intervention. This automated analysis and correction enables AM operations to utilize the disclosed methods in a PID-like closed loop quality control process. All parts, or a subset of parts (for example every 2^{nd} part or every 5^{th} part, or any other sequence of parts using a predetermined sampling methodology) from a production process may be scanned and passed to the disclosed methods' tolerance analysis and feature correction software, and the results may be looped back into the green part production to obtain better results in the next print cycle.

The various methods described in exemplary embodiments may be used to correct for any type of AM defect. This includes polymer warping due to curing and thermal effects, sand core swelling due to microwaving, and powder metal shrinkage and distortion due to density variations, gravity, and friction during sintering.

### BRIEF DESCRIPTION OF THE DRAWINGS

In the drawings, like reference characters generally refer to the same parts throughout the different views. The drawings are not necessarily to scale; emphasis instead generally being placed upon illustrating the principles of the invention. In the following description, various embodiments of the invention are described with reference to the following drawings, in which:

FIG. 1 shows a graphical representation of a electronic design for a part geometry according to an aspect of the present disclosure.

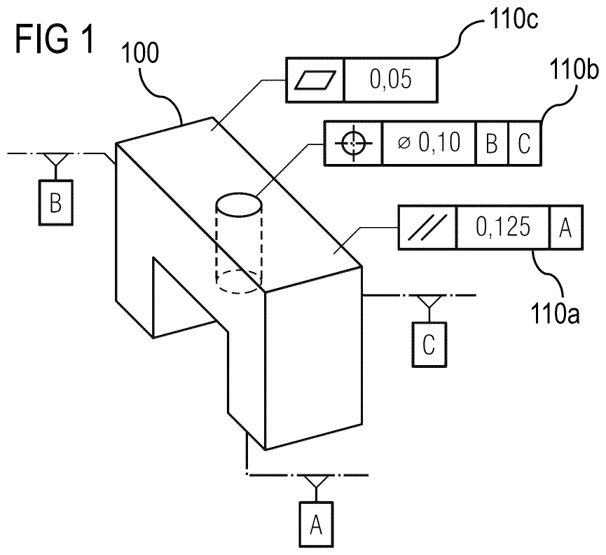

FIG. 2 shows a graphical representation of an electronic design for a part geometry and a corresponding electronic scan mapping of a part manufactured according to the electronic design for a part geometry.

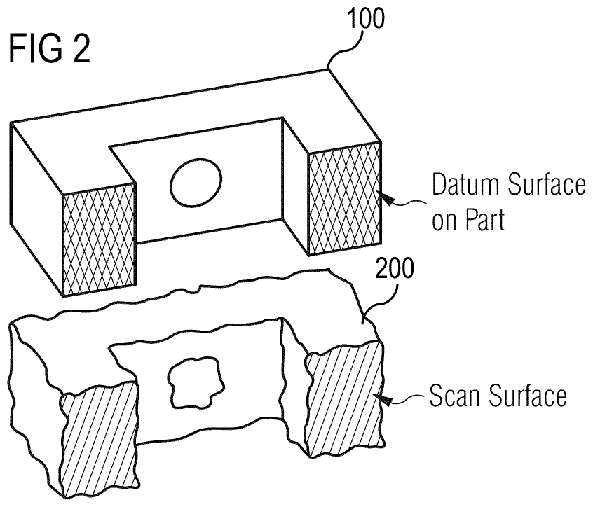

FIGS. 3A-3B show an example of successive alignments of electronic design part to an electronic scan mapping of manufactured part.

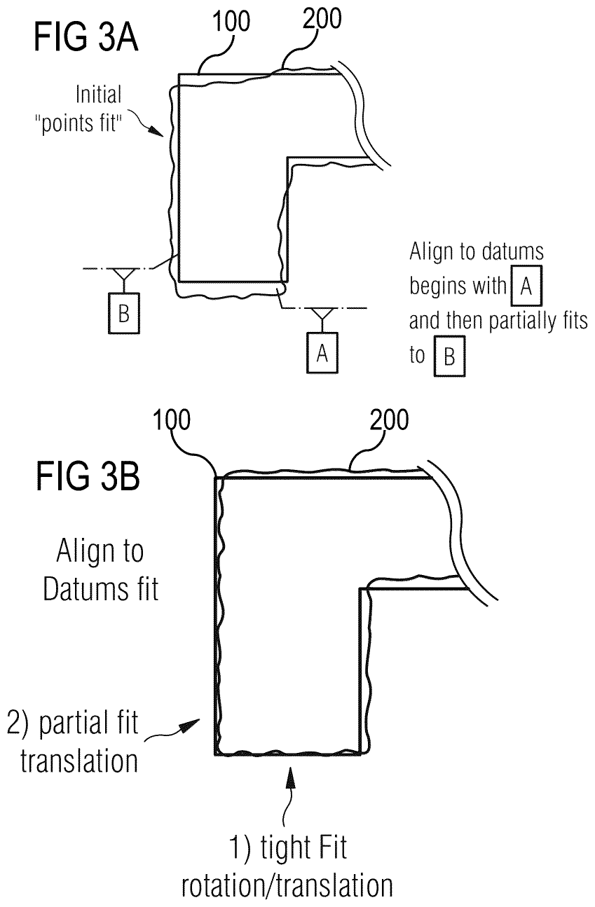

FIG. 4 shows a representation of the electronic design of a part geometry aligned to an electronic scan mapping of a part according to at least one aspect of the present disclosure.

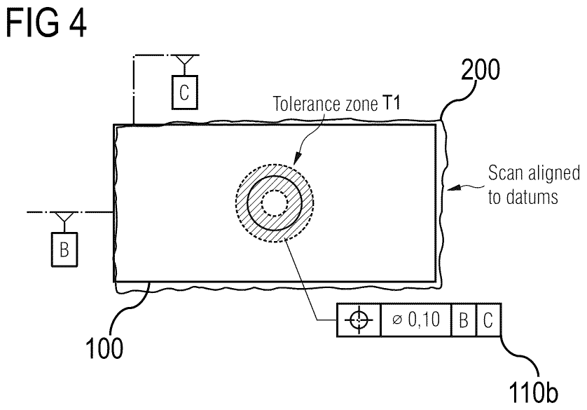

FIG. 5 shows a graphical representation of an electronic design for a part geometry according to an aspect of the present disclosure.

FIG. 6 shows a graphical representation of an electronic design for a part geometry fitted to an electronic scan mapping using an Iterative Point Cloud algorithm according to an aspect of the present disclosure.

FIGS. 7A and 7B show a graphical representation of electronic scan mapping fitted to an electronic design for a part geometry in which the fit gives equal weight to all points on the electronic scan mapping according to an aspect of the present disclosure.

FIG. 8 show a graphical representation of an electronic design for a part geometry fitted to an electronic scan mapping using a set of datum features defined on the electronic design for a part geometry according to an aspect of the present disclosure.

FIGS. 9A and 9B show a graphical representation of electronic scan mapping fitted to an electronic design for a part geometry in which the fitting is a partial fitting of the electronic scan mapping using datum surfaces according to an aspect of the present disclosure.

FIG. 10 shows a flow diagram of a method according to an aspect of the present disclosure.

### DETAILED DESCRIPTION

Various embodiments or aspects of the present disclosure relate to a tolerance-based analysis tool (e.g., software) colloquially referred to as Live Inspect (LI) within the present application. LI is a tool for analyzing scans relative to parts using GD&T terminology and practices. It also provides scan adjustment capabilities for individual analysis of features, based upon first aligning the scan to the part using datums. The various disclosed methods may include the following features:

1. Ability to specify one or more Analysis Features on a part.
1.1 An Analysis Feature (AF) has a reference to a surface on the part (plane, cylinder etc.).
1.2. To identify the surface on the part, the user uses either an analytic surfaces filter or a paint brush filter. LI then finds all the mesh triangles on the part associated with the surface. The set of part triangles is saved in the AF object for highlighting and use in operations that identify points on scans that are close to the AF surface.
1.3. Show list of AFs in a feature tree and allows AFs to be deleted.
1.4. Because each AF has a reference to a surface on the part, it will also have a set of points and triangles on a fitted scan that will be considered to be close to the AF. Later it will be described how a set of points and triangles on a scan will get associated with an AF.
1.5. The points on a scan that are associated with an AF will have a Fitted Surface (FS) like a plane or cylinder or axis, fitted to it. So if a user creates an AF and selects a plane on the part, then LA will find the points on the scan and will fit a plane through these points. This Fitted Surface will then be evaluated for properties relative to itself (i.e. flatness) and/or relative to other objects (see Datum Features below).

2. An Analysis Feature can be classified as a Datum Feature. These could be referred to as simply Datums.
2.1. Datum Features (DF) are a kind of AF that gets referenced (see Tolerances below). They represent key AFs on the part that are important when measuring the properties of other AFs.
2.2. An Analysis Feature has one or more Tolerances.
   1. A Tolerance is a measurement of a property of the AF that that the tolerance references. An example is a flatness Tolerance on a plane AF. When the user creates a Tolerance, it is associated with an AF. It is possible for a user to associate a single tolerance with multiple AFs, as well as multiple tolerances to a single AF. For an example of the first case, a flatness Tolerance could be associated with all the plane AFs on a part.
   2. Each Tolerance has a type. Examples include parallelism, perpendicularity, flatness, true position.
   3. An AF such as a plane can have multiple Tolerances associated with it-like one for perpendicularity and another for flatness. A cylinder AF might have a tolerance for concentricity, one for true position, and one for perpendicularity.
   4. Tolerances don't have names, but they have types. One may not define two tolerances of the same type associated with an AF, as this would lead to a conflict between the tolerance constraints.
   5. Each Tolerance has zero or more references to DFs (datum features).
      1. Having a reference to a DF depends upon the type of the Tolerance.
   2. Tolerance references to DFs help in evaluating the Tolerance relative to the AF that it is
   associated with. For example, a perpendicularity Tolerance on AF B (a plane) must also have a reference to DF A (a plane). A's plane must be used to align the scan to the part in the vicinity of DF A prior to evaluating the tolerance associated with AF B.

3. In preferred embodiments, no self or circularity referencing is allowed. DF B can have a Tolerance of type perpendicularity that references DF A, but the Tolerance cannot reference DF B, because this would be a self-reference. The first DF has no references because it must stand on its own.

4. A flatness Tolerance is an example that may have no reference to a DF. However, a perpendicularity Tolerance must have a reference to a DF.

5. A Tolerance has a value that defines a zone of allowed deviation around the AF that references it.
5.1. Example: Assume a perpendicularity Tolerance associated with AF B has a reference to DF A. Furthermore, the perpendicularity Tolerance has a value of 0.3 mm. This means that once the scan has been aligned to DF A, a pair of temporarily constructed zone planes defined relative to AF B's plane would have to fully enclose the scan points associated with AF B with a gap between them of no more than 0.3 mm.

6. New Command to Align a Scan to the Part Using DFs
6.1. There can be a command (Align to Datums) that will perform this tight datum alignment.
6.2. LA uses the scan to find the subsets of scan points that are near each of the AF surfaces. Then, LA uses higher weighting or priority for the scan points associated with the datum-based DF surfaces in tightly aligning the composite scan to the part. The result is that the scan is tightly fitted to the DF part surfaces. In certain embodiments, the non-datum type AFs are not used for tight alignment.
6.3. The algorithm for aligning the scan to the part using datum features (DFs) will start by finding a translation and rotation that best fits the subset of scan triangles associated with the first datum feature to the surface associated with the AF. For example, the first datum feature might be the bottom planar surface of a part. Aligning to this datum would involve finding all the triangles on the scan that are near the planar surface on the part, and then translating and rotating the scan such that these triangles of the scan tightly align to the plane on the part, at the expense of other triangles on the scan. Next, the scan would be further aligned to the second datum in the same way as the first alignment, except that the motion degrees of freedom would be reduced to prevent misaligning the first alignment. If the first alignment had fit the scan to a plane, then the second alignment would be free to translate in directions parallel to this plane and to rotate in a direction normal to this plane.
6.4. We may use the IPC (iterative point cloud) approach known to those of skill in the art for each of the successive alignments of the scan to the datum features. In one approach, we might use the IPC algorithm to come up with an unconstrained motion that aligns the portion of the scan to the part, and then go back and remove the degrees of freedom from the final transform such that any prior alignments are not mis-aligned by the current alignment. In another approach we may give the IPC algorithm a transform defining the allowable degrees of freedom, and let the IPC come up with an alignment that limits the translation and rotation to exist only in the allowable DOF's.

7. Show the Analysis Features in the feature tree. Provide a way of distinguishing the datum features from the other analysis features. Even though DFs are just a type of AF, people think of them as important and special.
7.1 Provide on-screen rendering of AF surface triangles with hide/show ability.
7.2. Provide on-screen rendering of DF symbols. Datum symbols have a box with the datum name (A, B, C, D, etc. . . . ) and an anchor line attached to the part surface (one of the triangles). Symbols are drawn in screen coordinates.

8. For each AF and DF shown in the feature tree, show its Tolerances as a sub-category.
8.1. So if an analysis feature (AF) plane has flatness and perpendicularity Tolerances, these two Tolerances would be listed as children of the AF.
8.2. Provide on-screen rendering of Tolerance symbols. The type of Tolerance indicates which symbol to use. The value of the tolerance should also be shown. The 2D symbol is drawn in screen coordinates and a line should join the tolerance symbol to the surface on the part for each AF that the tolerance is associated with.

9. Once a scan has been aligned to a sequence of datums-DFs, the AFs can then be evaluated using the Tolerances that reference that sequence of datums.
9.1. So each AF has a set of scan triangles and a set of part triangles associated with it. And there is the set of Tolerances that define the allowable relationships between the scan and part triangles.
9.2. First, LA will fit a copy of the feature surface (i.e. plane, cylinder) through the scan triangles associated with each of the features. This is called a Fitted Surface (FS).
9.3. Then, for each Tolerance, LA will evaluate properties of the Fitted Surface against the part surface that's associated with the AF. As an example, for a parallelism Tolerance, the Tolerance will reference a “target” Analysis Feature B that has a reference to a part plane. Additionally, there will be a set of scan triangles associated with the AF, along with a Fitted Surface plane that has been fitted through these scan triangles. The Tolerance will also have a reference to a Datum Feature A that references a plane on the part that is supposed to be perpendicular to the Analysis Feature B's plane. So, to analyze the parallelism tolerance, LA will First align the scan to DF A. Next it will construct a “tolerance zone” using the tolerance's AF B, and then will analyze whether or not the fitted surface, derived from offsetting surfaces from AF B by the tolerance amount, fits within this allowable tolerance zone. To construct the tolerance zone, LA will create two tolerance zone planes that are parallel to plane A, and then offset these planes by the allowable tolerance. If the Fitted Surface plane of Analysis Feature B lies completely between these zone planes, then the tolerance is met.
9.4. Upon evaluating the tolerances, we highlight which tolerances fail and which pass in red and green respectively.

Datums may be assigned priorities. For example, when a second datum has a priority lower than a first datum it may be that a lock is performed in certain degrees of freedom with respect to the first datum so that the alignment to the second datum is limited in motion so that the alignment to the first datum is not broken. For a particular tolerance, the priorities of the datums may be defined by the order in which they are listed in the sequence of datums referenced by the tolerance.

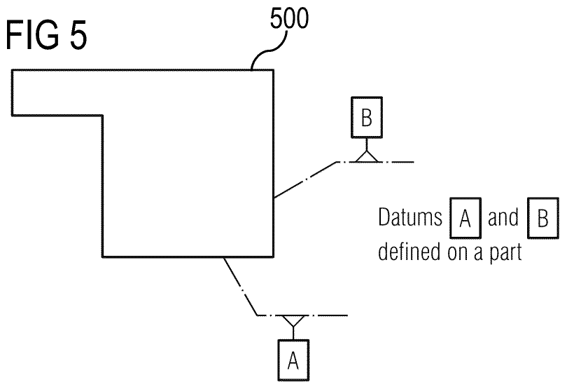

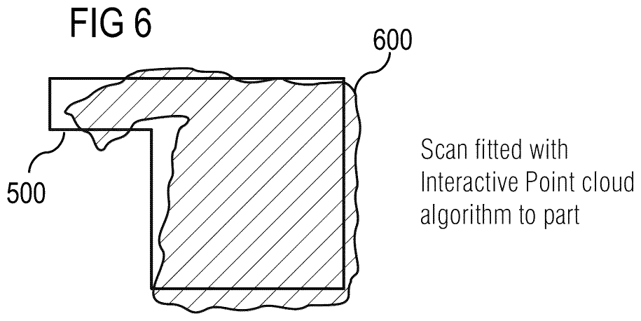

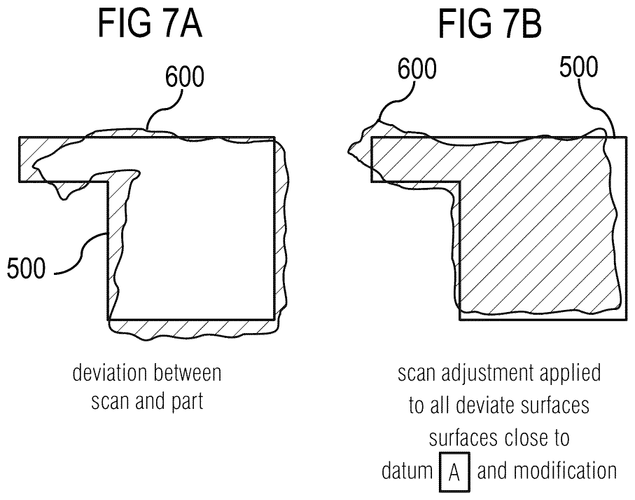

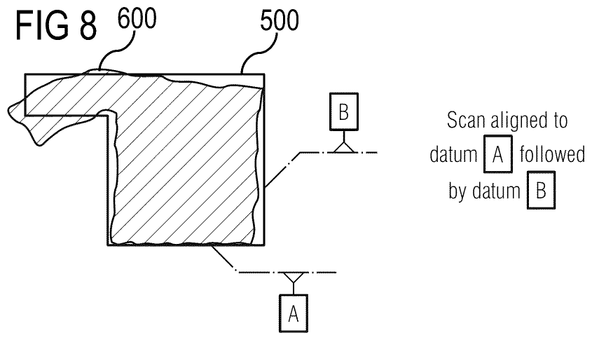

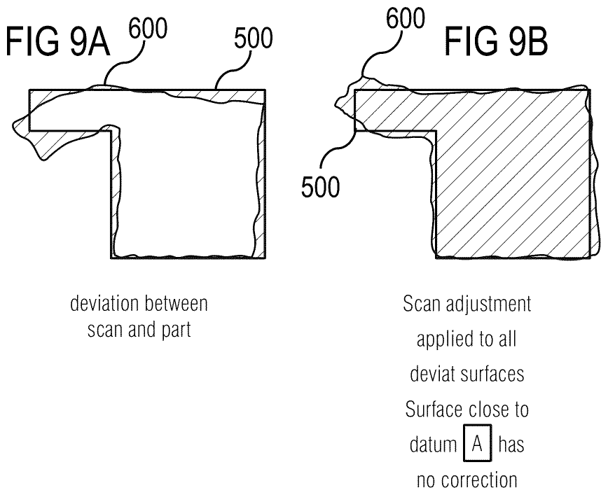

FIG. 5 show an exemplary graphical representation of an electronic design for a part geometry 500. FIGS. 6-9 are exemplary illustrations hat illustrate the concept of fitting a scan (e.g., electronic scan mapping 600) generally to a part (electronic design for part geometry 500) using an Iterative Point Cloud algorithm (see e.g., FIG. 6) versus fitting the scan using a set of Datum features defined on the part (see e.g., FIG. 8). When the scan is fit generally giving equal weight to all points on the scan, the scan adjustment process ends up modifying all surfaces of the part (see e.g., FIGS. 7A and 7B). However, if the scan is fit to the part using a sequence of Datums—meaning we tightly fit the scan to the surface of Datum A, followed by partially fitting the scan to the surface of Datum B (without violating the tight fit to A) we end up doing a scan adjustment that minimally affects the surfaces A and B of the part (see FIGS. 9A and 9B). In this example, the scan adjustment is applied to a slightly scaled up version of the part, and a scan adjustment applies the opposite compensation to the part (including scaling) as defined by the deviation of the scan to the part.

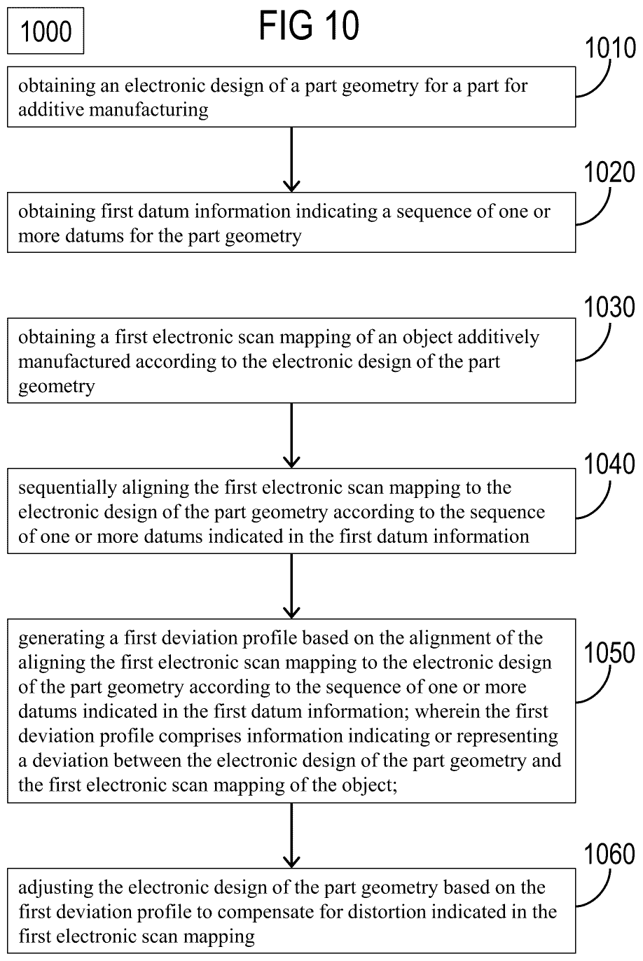

FIG. 10 shows a method 1000. The method 100 can be in at least one example for compensating distortion in sintered objects/3D printed objects to maintain desired geometry features. The method 1000 can be implemented by one or more processors executing instructions stored on computer-readable media. The method 1000 can include at 1010, obtaining an electronic design of a part geometry for a part for additive manufacturing. At 1020, the method 1000 includes obtaining first datum information indicating a sequence of one or more datums for the part geometry. At 1030, the method 1000 includes obtaining a first electronic scan mapping of an object additively manufactured according to the electronic design of the part geometry. At 1040, the method 1000 includes sequentially aligning the first electronic scan mapping to the electronic design of the part geometry according to the sequence of one or more datums indicated in the first datum information. At 1050, the method 1000 includes generating a first deviation profile based on the alignment of the aligning the first electronic scan mapping to the electronic design of the part geometry according to the sequence of one or more datums indicated in the first datum information; wherein the first deviation profile comprises information indicating or representing a deviation between the electronic design of the part geometry and the first electronic scan mapping of the object. At 1060, the method 1000 includes adjusting the electronic design of the part geometry based on the first deviation profile to compensate for distortion indicated in the first electronic scan mapping. The adjusted electronic design can be sent to or obtained by an additive manufacturing printer (e.g., 3D printer) which can then manufacture a part by using or applying the adjusted electronic design for part geometry. Further, examples of analysis and scan adjustment process can be applied to any part, whether it has been previously scan-adjusted or not. The software may only need access to the design model, the scan data, and the digital version of the printed part. For instance, if a scan adjustment has already been performed, the saved model includes the design, the original scan, and the corresponding scan-adjusted geometry. For example, to proceed with a new scan adjustment, the original scan can be deleted with a new scan of the second printed part uploaded, based on the previous scan adjustment. The software can then analyze and align the new scan relative to the design model, applying a second scan adjustment to further refine the previously adjusted geometry. This iterative process can continue, with each new scan adjustment progressively aligning the geometry closer to the design, until the final scan closely matches the intended design.

Exemplary embodiments of the present disclosure may be realized by one or more computers (or computing devices) reading out and executing computer-executable instructions recorded on a storage medium (e.g., non-transitory computer-readable storage medium) to perform the functions of one or more of the herein-described embodiment(s) of the disclosure. The computer(s) may comprise one or more of a central processing unit (CPU), a microprocessing unit (MPU), or other circuitry, and may include a network of separate computers or separate computer processors. The computer-executable instructions may be provided to the computer, for example, from a network or a non-volatile computer-readable storage medium. The storage medium may include, for example, one or more of a hard disk, a random-access memory (RAM), a read-only memory (ROM), a storage of distributed computing systems, an optical drive (such as a compact disc (CD), digital versatile disc (DVD), or Blu-ray Disc (BD), a flash memory device, a memory card, and the like. By way of illustration, specific details and embodiments in which the invention may be practiced.

Throughout this specification, plural instances may implement components, operations, or structures described as a single instance. Although individual operations of one or more methods are illustrated and described as separate operations, one or more of the individual operations may be performed concurrently. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The term “software” refers to any type of executable instruction, including firmware.

Unless specifically stated otherwise, discussions herein using words such as “processing,” “computing,” “calculating,” “determining,” “presenting,” “displaying,” or the like may refer to actions or processes of a machine (e.g., a computer/processor/etc.) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

The word “exemplary” is used herein to mean “serving as an example, instance, or illustration.” Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”. “sequence (of)”, “grouping (of)”, etc., and the like in the description or in the claims refer to a quantity equal to or greater than one, i.e., one or more. Any term expressed in the plural form that does not expressly state “plurality” or “multiple” likewise refers to a quantity equal to or greater than one. The terms “proper subset”, “reduced subset”, and “lesser subset” refer to a subset of a set that is not equal to the set, i.e., a subset of a set that contains fewer elements than the set.

The terms “at least one” and “one or more” may be understood to include a numerical quantity greater than or equal to one (e.g., one, two, three, four, [. . . ], etc.). As used herein, unless otherwise specified, the use of the ordinal adjectives “first”, “second”, “third”, etc., to describe a common object merely indicate that different instances of like objects are being referred to, and are not intended to imply that the objects so described must be in a given sequence, either temporally, spatially, in ranking, or in any other manner.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. However, the term data is not limited to the aforementioned examples and may take various forms and represent any information as understood in the art.

The term “processor” or “controller” as, for example, used herein may be understood as any kind of entity that allows handling data, signals, etc. The data, signals, etc., may be handled according to one or more specific functions executed by the processor or controller.

It should be noted that one or more of the features of any of the examples above may be suitably or appropriately combined with any one of the other examples. The foregoing description has been given by way of example only and it will be appreciated by those skilled in the art that modifications may be made without departing from the broader spirit or scope of the invention as set forth in the claims. The specification and drawings are therefore to be regarded in an illustrative sense rather than a restrictive sense.

The scope of the disclosure is thus indicated by the appended claims and all changes which come within the meaning and range of equivalency of the claims are therefore intended to be embraced.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed:

1. A computer-implemented method comprising:
obtaining an electronic design of a part geometry for a part for additive manufacturing;
obtaining first datum information indicating a sequence of one or more datums for the part geometry,
obtaining a first electronic scan mapping of an object additively manufactured according to the electronic design of the part geometry;
sequentially aligning the first electronic scan mapping to the electronic design of the part geometry according to the sequence of one or more datums indicated in the first datum information;
generating a first deviation profile based on the alignment of the aligning the first electronic scan mapping to the electronic design of the part geometry according to the sequence of one or more datums indicated in the first datum information; wherein the first deviation profile comprises information indicating or representing a deviation between the electronic design of the part geometry and the first electronic scan mapping of the object;
adjusting the electronic design of the part geometry based on the first deviation profile to compensate for distortion indicated in the first electronic scan mapping.

2. The method of claim 1, wherein for each of the one or more datums of the sequence, the first datum information indicates an associated tolerance of a type including parallelism, perpendicularity, flatness, and true position, concentricity, runout, circularity, straightness, cylindricity, symmetry, and/or angularity tolerance.

3. The method of claim 2, further comprising:
performing a tolerance analysis after sequentially aligning the first electronic scan mapping to the electronic design of the part geometry; and
generating a go-no-go report based on the tolerance analysis as to whether a tolerance was achieved according to the aligned scan mapping.

4. The method of claim 1, wherein the first datum information indicates at least a first datum.

5. The method of claim 4, wherein sequentially aligning the first electronic scan mapping to the electronic design comprises:
aligning the first electronic scan mapping to the electronic design according to the first datum of the first datum information.

6. The method of claim 5, wherein the first datum information indicates at a least second datum, wherein the first datum precedes the second datum in the sequence of the one or more datums.

7. The method of claim 6, wherein sequentially aligning the first electronic scan mapping to the electronic design further comprises aligning the first electronic scan mapping aligning the first electronic scan mapping to the electronic design according to the second datum which is performed after aligning the first electronic scan mapping aligning the first electronic scan mapping to the electronic design according to the first datum.

8. The method of claim 7, wherein aligning the first electronic scan mapping to the electronic design according to the second datum is subject to a constraint that the previous alignment of the first electronic scan mapping to the electronic design according to the first datum is maintained or is not broken.

9. The method of claim 8, wherein the first datum information indicates at least a third datum, wherein the second datum precedes the third datum in the sequence of the one or more datums of the first datum information.

10. The method of claim 9, wherein sequentially aligning the first electronic scan mapping to the electronic design further comprises aligning the first electronic scan mapping to the electronic design according to the third datum which is performed after aligning the first electronic scan mapping to the electronic design according to the second datum.

11. The method of claim 10, wherein the aligning of the first electronic scan mapping to the electronic design according to the third datum is subject to a constraint that previous alignments of the first electronic scan mapping to the electronic design according to the first and second datums are maintained or are not broken.

12. The method of claim 1, wherein the first electronic scan mapping comprises a composite of a plurality of scans of multiple instances of the object.

13. The method of claim 1, further comprising:
generating a compensation profile based on the first deviation profile, the compensation profile indicating compensations to be applied to the electronic design;
wherein adjusting the electronic design of the part geometry based on the first deviation profile comprises applying the compensation profile to the electronic design.

14. The method of claim 13,
wherein the first deviation profile comprises a 3D representation corresponding to at least one aspect of the object additively manufactured, and
wherein the compensation profile comprises a 3D representation corresponding to at least an aspect of the electronic design.

15. The method of claim 1, further comprising:
additively manufacturing a further object according to the adjusted design of the part geometry.

16. The method of claim 1, further comprising
obtaining a second datum information indicating a sequence of one or more datums for the part geometry,
sequentially aligning the first electronic scan mapping to the electronic design of the part geometry according to the second sequence of one or more datums indicated in the second datum information;
generating a second deviation profile based on the alignment of the electronic scan mapping to the electronic design of the part geometry, wherein the second deviation profile comprises information indicating or representing a deviation between the electronic design of the part geometry and the first electronic scan mapping of the object;
further adjusting the electronic design of the part geometry based on the second deviation profile.

17. The method of claim 16,
wherein the second datum information indicates a sequence of datums that include at least one datum that is difference from at least one of the one or more datums of the first datum information, and
wherein the second deviation profile differs from the first deviation profile.

18. The method of claim 17,
wherein adjusting the electronic design of the part geometry based on the first deviation profile to compensate for distortion indicated in the first electronic scan mapping comprises adjusting a first portion of the electronic design of the part geometry, and
wherein adjusting the electronic design of the part geometry based on the second deviation profile to compensate for distortion indicated in the first electronic scan mapping comprises adjusting a second portion of the electronic design of the part geometry, and
wherein the second portion is different from the first portion of the electronic design of the part geometry.

19. The method of claim 16, further comprising:
additively manufacturing a further object according to the design of the part geometry adjusted based on the first and second deviation profiles.

20. A non-transitory computer-readable media storing instructions that when executed by at least one processor cause the at least one processor to:
obtain an electronic design of a part geometry for a part for additive manufacturing;
obtain datum information indicating a sequence of one or more datums for the part geometry,
obtain an electronic scan mapping of an object additively manufactured according to the electronic design of the part geometry;
sequentially align the electronic scan mapping to the electronic design of the part geometry according to the sequence of one or more datums indicated in the datum information;
generate a deviation profile based on the alignment of the electronic scan mapping to the electronic design of the part geometry, wherein the deviation profile comprises information representing a deviation between the electronic design of the part geometry and the electronic scan mapping of the object;
adjust the electronic design of the part geometry based on the deviation profile to compensate for distortion indicated in the electronic scan mapping.
